(19) United States
(12) Patent Application Publication
(10) Pub. No.: US 2023/0022932 A1
(43) Pub. Date: Jan. 26, 2023

(54) GAS CUSHION BAG

(71) Applicant: Chun-Wei LIN, Taichung City (TW)

(72) Inventor: Chun-Wei LIN, Taichung City (TW)

(21) Appl. No.: 17/506,073

(22) Filed: Oct. 20, 2021

(30) Foreign Application Priority Data
Jul. 23, 2021 (TW) 110208681

(51) Int. Cl. B65D 81/05; B31D 5/00

(52) U.S. Cl. CPC B65D 81/052; B31D 5/0073

(57) ABSTRACT

A gas cushion bag includes two layers, and the two layers are overlapped with each other and partially connected with each other to form a plurality of connecting portions and at least one gas storage unit. Each of the at least one gas storage unit is sealed circumferentially and includes at least one first segment and a plurality of second segments communicated with the at least one first segment. The at least one first segment and the plurality of second segments are alternatively arranged in a first direction. Wherein as viewed along the first direction, a cross-sectional profile of each of the at least one first segment is smaller than a cross-sectional profile of one of the plurality of second segments when the at least one gas storage unit is inflated.

### BACKGROUND OF THE INVENTION

### Field of the Invention

The present invention relates to a gas cushion bag.

### Description of the Prior Art

Common packaging materials include bubble wrap, air column bag, honeycomb paper, foam cushion, etc., to provide shock absorption and cushioning effects to an object 200 being transported. Please refer to FIGS. 12 to 14, a conventional air column bag 100 includes two membranes 101 overlapped with each other, and the two membranes 101 are circumferentially connected with each other by heat-sealing to form a gas storage unit 102. Therefore, the gas storage unit 102 is inflatable to provide shock absorption and cushioning effects.

However, the gas storage unit 102 of the conventional air column bag 100 has a single diametrical dimension, and the two membranes 101 are moved away from each other and respectively form an arcuate surface after inflation. Therefore, the inflated gas storage unit 102 contacts an object 200 by the arcuate surface (the dotted area in FIG. 12), which results in large local pressure to the gas storage unit 102, poor cushioning effect and poor supporting stability. The object 200 packaged by the air column bag 100 is easy to move during transportation. Moreover, the air column bag 100 is a one-time consumable made of plastic, which may result in environmental burden.

The present invention is, therefore, arisen to obviate or at least mitigate the above-mentioned disadvantages.

### SUMMARY OF THE INVENTION

The main object of the present invention is to provide a gas cushion bag, which provides good supporting stability and cushioning effect. In addition, the use of plastic is reduced so that the gas cushion bag is low cost.

To achieve the above and other objects, the present invention provides a gas cushion bag, including two layers. The two layers are overlapped with each other and partially connected with each other to form a plurality of connecting portions and at least one gas storage unit. Each of the at least one gas storage unit is sealed circumferentially and includes at least one first segment and a plurality of second segments communicated with the at least one first segment. The at least one first segment and the plurality of second segments are alternatively arranged in a first direction. Wherein as viewed along the first direction, a cross-sectional profile of each of the at least one first segment is smaller than a cross-sectional profile of one of the plurality of second segments when the at least one gas storage unit is inflated.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a front view of a first preferable embodiment of the present invention;

FIG. 2 is a cross-sectional view of FIG. 1;

FIG. 3 is a front view of the first preferable embodiment of the present invention when there are two gas storage units;

FIG. 4 is a schematic diagram of the first preferable embodiment of the present invention in use;

FIG. 5 is a side view of the first preferable embodiment of the present invention in use;

FIG. 6 is another side view of the first preferable embodiment of the present invention in use;

FIG. 7 is a front view of a second preferable embodiment of the present invention;

FIG. 8 is a side view of the second preferable embodiment of the present invention;

FIG. 9 is a front view of the second preferable embodiment of the present invention when there are a plurality of gas storage units;

FIG. 10 is a schematic diagram of the second preferable embodiment of the present invention in use;

FIG. 11 is a side view of the second preferable embodiment of the present invention in use;

FIG. 12 is a schematic diagram of a conventional air column bag in use;

FIG. 13 is a side view of the conventional air column bag in use; and

FIG. 14 is another side view of the conventional air column bag in use.

### DETAILED DESCRIPTION OF THE PREFERRED EMBODIMENTS

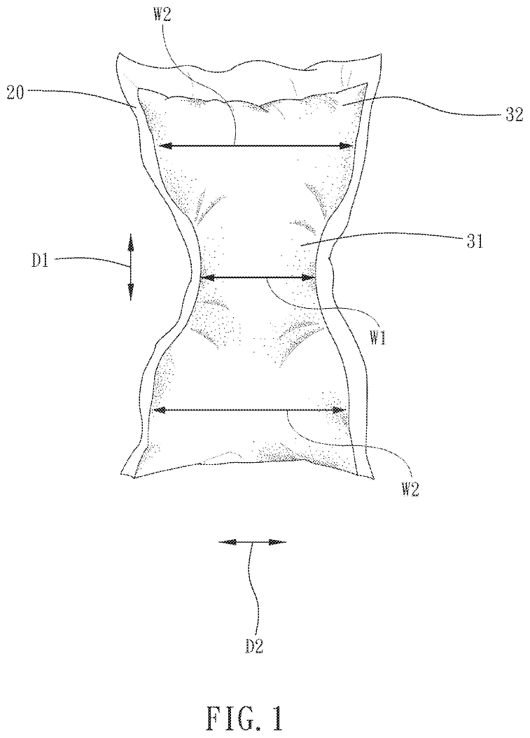

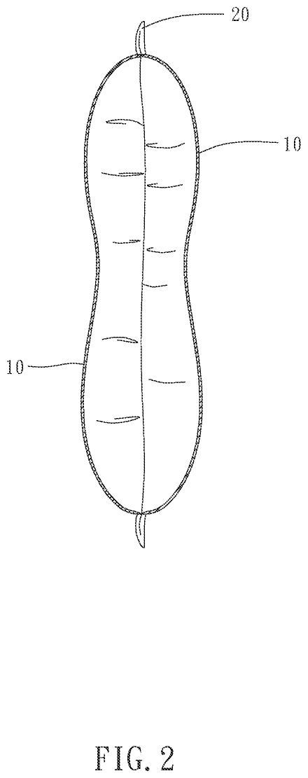

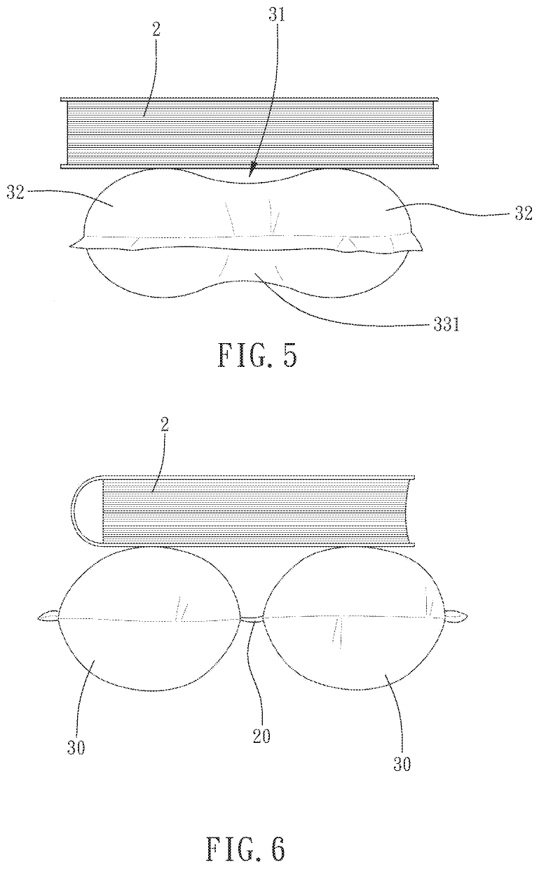

Please refer to FIGS. 1 to 6 for a first preferable embodiment of the present invention. A gas cushion bag 1 of the present invention includes two layers 10, and the two layers 10 are overlapped with each other and partially connected with each other to form a plurality of connecting portions 20 and at least one gas storage unit 30. Each of the at least one gas storage unit 30 is sealed circumferentially and includes at least one first segment 31 and a plurality of second segments 32 communicated with the at least one first segment 31. The at least one first segment 31 and the plurality of second segments 32 are alternatively arranged in a first direction D1. As viewed along the first direction D1, a cross-sectional profile of the at least one first segment 31 is smaller than a cross-sectional profile of one of the plurality of second segments 32 when the at least one gas storage unit 30 is inflated, which provides good cushioning effect, reduces the use of plastic and is low cost.

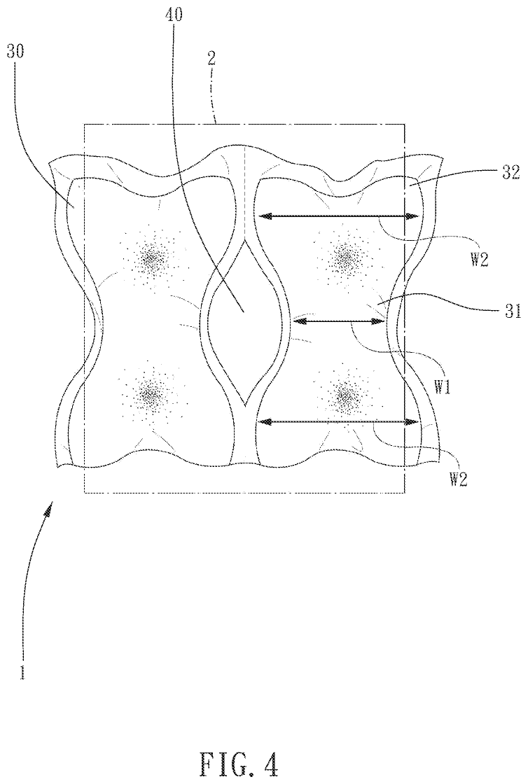

Please refer to FIG. 1, in a second direction D2 lateral to the first direction D1, each of the at least one first segment 31 has a first width W1, and each of the plurality of second segments 32 has a second width W2 which is larger than or equal to one said first width W1. When the at least one gas storage unit 30 is inflated, the plurality of second segments 32 provide large contact areas to disperse force exerted thereon. Moreover, a value of a ratio of one said second width W2 to one said first width W1 is between 1.0 and 3.0 (preferably between 1.2 and 2.0). In this embodiment, said second widths W2 of the plurality of second segments 32 are the same with one another, and the value of the ratio of one said second width W2 to one said first width W1 is 1.67. Therefore, the plurality of second segments 32 provide stable support after inflation, and the at least one first segment 31 has sufficient structural strength. A volume of each of the plurality of second segments 32 is larger than a volume of each of the at least one first segment 31 when the at least one gas storage unit 30 is inflated. Therefore, each said gas storage unit 30 provides multiple contacts surfaces spaced apart from one another (the dotted area in FIG. 4) to contact an object 2 so as to have good supporting stability and good good pressure resistant.

The at least one gas storage unit 30 further includes a plurality of notches 33 corresponding to the at least one first segment 31, and two of the plurality of notches 33 are located at two opposite sides of one of the at least one first segment 31 and are symmetrical to each other so that two opposite sides of the at least one first segment 31 can equally bear the pressure. In addition, the use of raw material of the gas cushion bag 1 may be reduced relative to a conventional gas cushion bag. Preferably, each of the plurality of notches 33 is recessed in a direction toward one of the at least one first segment 31 and forms an arcuate surface 331 when the at least one gas storage unit 30 is inflated. Therefore, the pressure in the at least one gas storage unit 30 is gradually reduced from the at least one first segment 31 toward the plurality of second segments 32, which avoids large pressure differences therebetween.

In this embodiment, each of the plurality of connecting portions 20 is formed by heat-sealing of the two layers 10. During manufacturing, a gas is continuously blown between the two layers 10, and the two layers 10 are partially connected with each other by heat-sealing to form the at least one gas storage unit 30. However, the two layers may be directly connected to form the at least one gas storage unit without blowing, and a charging mouth may be disposed on each said gas storage unit so as to reduce a volume of the gas cushion bag for easy storage and transportation.

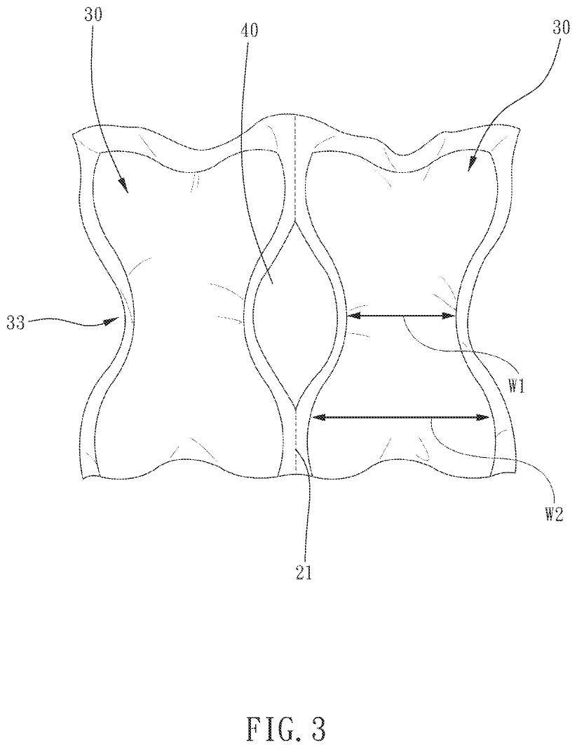

According to the process described above, the gas cushion bag 1 may include a plurality of said gas storage units 30. The two layers 10 preferably has at least one through hole 40 disposed therethrough and located between two of the plurality of said gas storage units 30, and the at least one through hole 40 corresponds to the at least one first segment 313. The residue of the two layers 10 is reusable to reduce waste of raw materials. In this embodiment, each said gas storage unit 30 is in a butterfly shape and includes one said first segment 31 and two said second segments 32. A contours of each of the at least one through hole 40 extends correspondingly to adjacent two of said first segments 31 and is spindle-shaped, as shown in FIG. 3, to remove excess margins. In the second direction D2, a width of each of the at least one through hole 40 is preferably larger than or equal to ½ of one said first width W1 so that the gas cushion bag 1 is easy to be folded for package. Also, the gas cushion bag 1 can be sleeved to a projection of the object 2 by the at least one through hole 40 to avoid damage. The plurality of connecting portions 20 preferably have a plurality of tear lines 21 disposed thereon, and each of the plurality of tear lines 21 is located between adjacent two of the plurality of said gas storage units 30 and extends to one of the at least one through hole 40 so that the plurality of gas storage unit 30 are easy to be torn apart from one another. In other embodiments, a shape of each said through hole may be circle, square, long, ellipse, triangle, irregular polygon, etc.

Please refer to FIGS. 4 to 6, when the plurality of said gas storage units 30 are inflated, a distance of the two layers 10 in one of the plurality of second segments 32 is larger than a distance of the two layers 10 in one of the at least one first segment 31. Therefore, each of the plurality of said gas storage units 30 is abuttable against the object 2 by the plurality of second segments 32 so as to stably support the object 2 and have good pressure resistant effect. In addition, the plurality of said gas storage units 30 connected with one another also can provide multiple supporting surfaces spaced apart from one another, as shown in FIG. 6, so as to have good supporting effect and force dispersion effect.

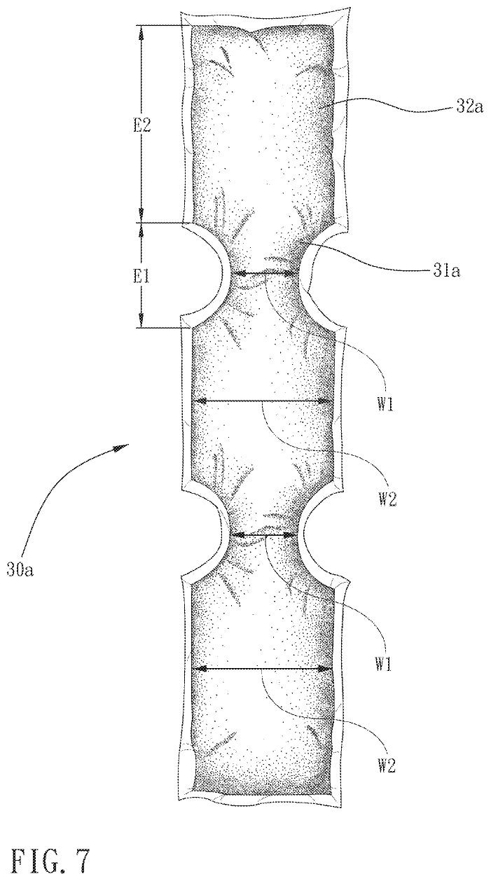

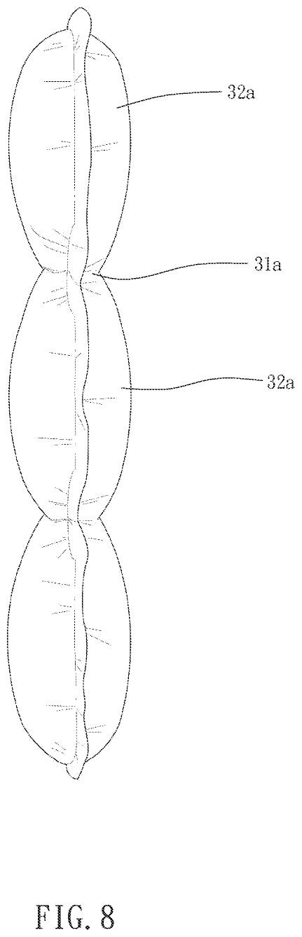

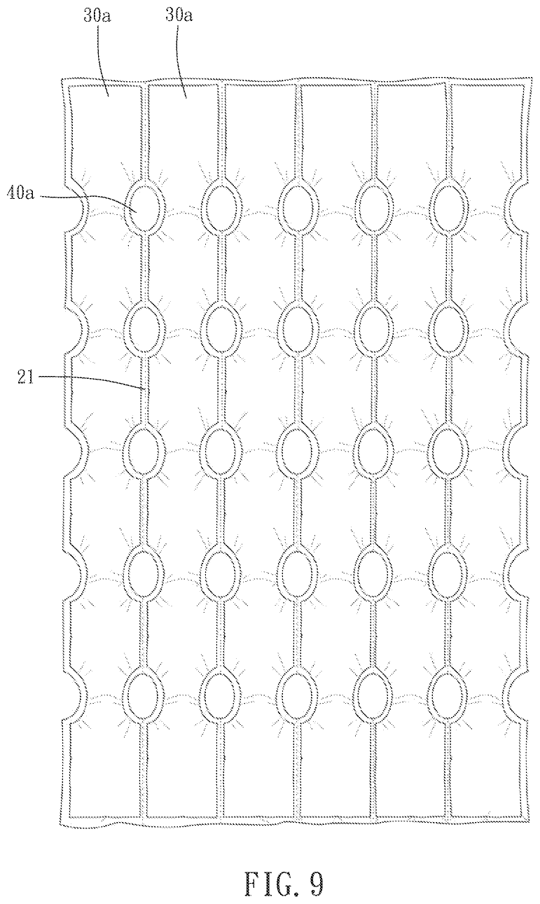

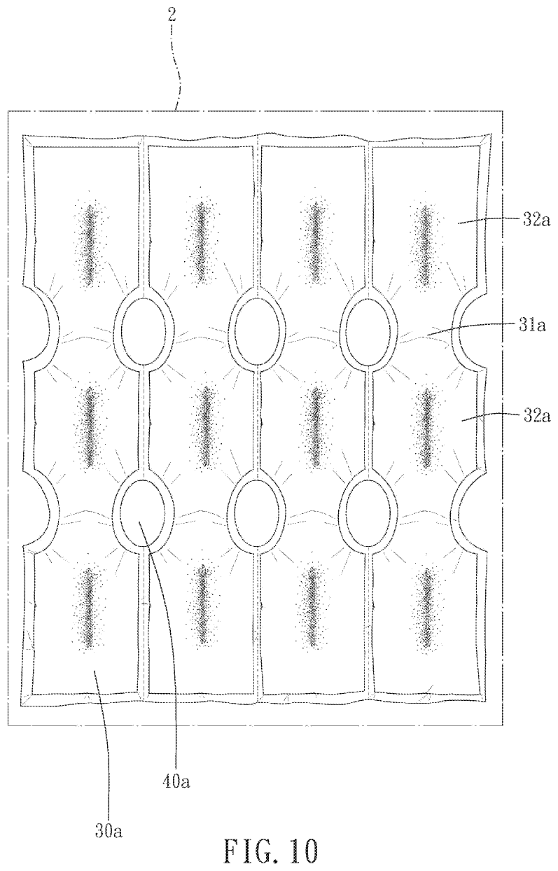

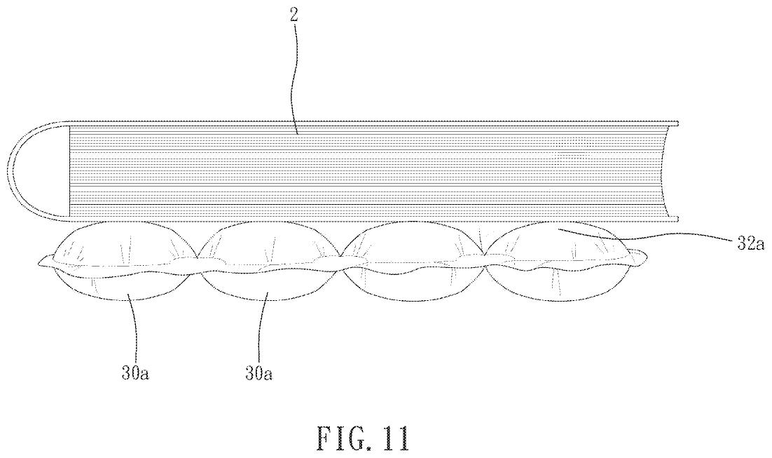

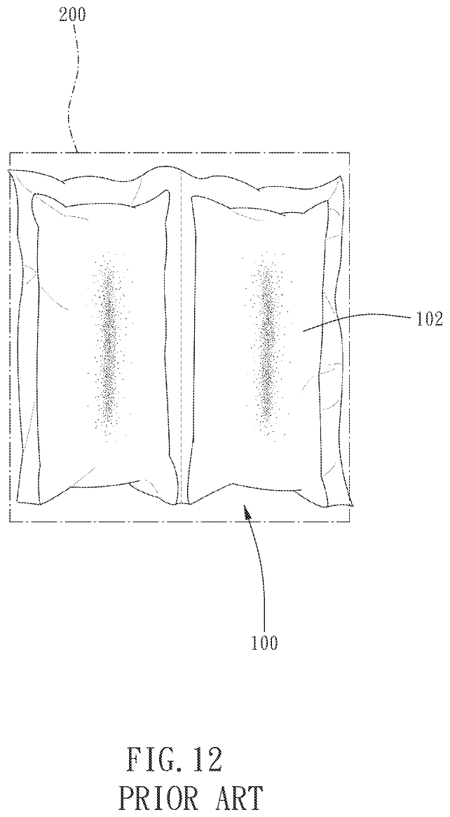

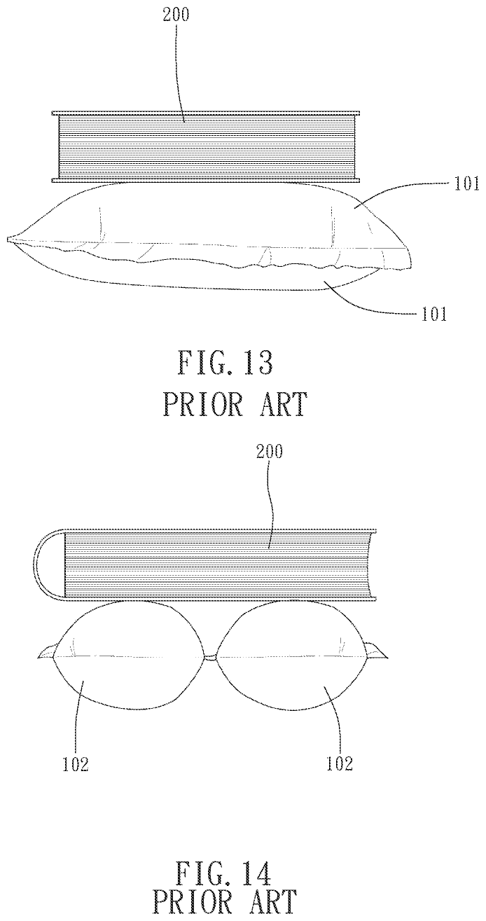

Please refer to FIGS. 7 to 11 showing a second preferable embodiment. Each of the plurality of said gas storage units 30a is elongated and includes two said first segments 31a and three said second segments 32a. Each said through hole 40a is oval. In the first direction D1, an extending length E1 of each of the two said first segments 31a is smaller than an extending length E2 of each of the three said second segments 32a so that the three said second segments 32a can provide large contact areas (the dotted area in FIG. 10), good supporting stability and good pressure resistant effect. In other embodiment, a shape of each said gas storage unit, a number of said first segments and a number of said second segments are changeable to meet various requirements.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A gas cushion bag, including: two layers, overlapped with each other and partially connected with each other to form a plurality of connecting portions and at least one gas storage unit, each of the at least one gas storage unit sealed circumferentially and including at least one first segment and a plurality of second segments communicated with the at least one first segment, the at least one first segment and the plurality of second segments being alternatively arranged in a first direction;
wherein as viewed along the first direction, a cross-sectional profile of each of the at least one first segment is smaller than a cross-sectional profile of one of the plurality of second segments when the at least one gas storage unit is inflated.

2. The gas cushion bag of claim 1, wherein in a second direction lateral to the first direction, each of the at least one first segment has a first width, and each of the plurality of second segments has a second width which is larger than or equal to one said first width.

3. The gas cushion bag of claim 2, wherein a value of a ratio of one said second width to one said first width is between 1.0 and 3.0.

4. The gas cushion bag of claim 1, wherein the at least one gas storage unit further includes a plurality of notches corresponding to the at least one first segment, and two of the plurality of notches are located at two opposite sides of one of the at least one first segment and are symmetrical to each other.

5. The gas cushion bag of claim 1, including a plurality of said gas storage units, wherein the two layers has at least one through hole disposed therethrough and located between two of the plurality of said gas storage units, and the at least one through hole corresponds to the at least one first segment.

6. The gas cushion bag of claim 5, wherein the plurality of connecting portions has a plurality of tear lines disposed thereon, and each of the plurality of tear lines is located between adjacent two of the plurality of said gas storage units and extends to one of the at least one through hole.

7. The gas cushion bag of claim 1, wherein a volume of each of the plurality of second segments is larger than a volume of each of the at least one first segment when the at least one gas storage unit is inflated.

8. The gas cushion bag of claim 6, wherein in a second direction lateral to the first direction, each of the at least one first segment has a first width, and each of the plurality of second segments has a second width which is larger than or equal to one said first width; said second widths of the plurality of second segments are the same with one another; a value of a ratio of one said second width to one said first width is between 1.2 and 2.0; each said gas storage unit further includes a plurality of notches corresponding to the at least one first segment, and two of the plurality of notches are located at two opposite sides of one of the at least one first segment and are symmetrical to each other; each of the plurality of notches is recessed in a direction toward one of the at least one first segment and forms an arcuate surface when the at least one gas storage unit is inflated; a volume of each of the plurality of second segments is larger than a volume of each of the at least one first segment when the at least one gas storage unit is inflated; each of the plurality of connecting portions is formed by heat-sealing of the two layers; and in the second direction, a width of each of the at least one through hole is larger than or equal to ½ of one said first width.
